(19) United States
(12) Patent Application Publication
(10) Pub. No.: US 2010/0037381 A1
(43) Pub. Date: Feb. 18, 2010

(54) TOILET APPARATUS

(75) Inventor: David Bowen, Dewsbury (GB)

Correspondence Address: CLARK & ELBING LLP, 101 FEDERAL STREET, BOSTON, MA, 02110, US

(73) Assignee: LOGICOR LIMITED, Wakefield (GB)

(21) Appl. No.: 12/517,289

(22) PCT Filed: May 1, 2007
(86) PCT No.: PCT/GB07/01593

§ 371 Date: Oct. 30, 2009

(30) Foreign Application Priority Data
Dec. 5, 2006 (GB) 0624237.4

(51) Int. Cl. E03D 9/08; E03D 9/00; A47K 3/022; A61H 35/00

(52) U.S. Cl. 4/420.4; 4/255.06; 4/444; 4/448; 4/666

(57) ABSTRACT

Toilet cleaning apparatus is provided including dispensing means for dispensing fluid therefrom for cleaning the toilet and connection means for connecting the dispensing means to a fluid supply for providing a source of fluid to the dispensing means in use. The dispensing means includes a housing having fluid inlet means and fluid outlet means. The housing includes two or more parts and the parts are rotatably mounted to each other in use.

This invention relates to toilet apparatus, to a cleaning or dispensing device for use with toilet apparatus and to a method of using a dispensing or cleaning device.

Although the following description refers almost exclusively to conventional toilet apparatus having a toilet bowl and toilet cistern associated therewith, it will be appreciated by persons skilled in the art that the toilet apparatus of the present invention could be used with any type of toilet or bathroom apparatus, such as a urinal, bidet, non-conventional toilet and/or the like.

A conventional toilet typically includes a toilet bowl with a toilet lid and/or seat associated with an upper surface thereof to allow a user to sit comfortably on the same in use. A cistern is connected to the toilet bowl to allow water contained in the cistern to flow into the toilet bowl following a user actuated flush to clear the toilet bowl after use. Clearance of the toilet bowl using the flushing water takes place via a siphon mechanism. The water typically enters the toilet bowl from the cistern at the same place or places after a toilet flush. The flow of water over the interior surface of the toilet bowl following a flush does provide a certain level of cleaning of the interior surface of the toilet bowl. However, most flush systems allow the flow of flushing water over a fixed part only of the toilet bowl and so there is normally at least part of the toilet bowl which is not cleaned after flushing. Furthermore, the water entering the toilet bowl from the cistern may not be of sufficient pressure or quantity to provide an adequate cleaning effect.

In order to overcome the abovementioned problem, it is known to provide a toilet brush in a bathroom or toilet environment to allow a user to specifically clean part or parts of an interior surface of a toilet bowl after use. The toilet brush is typically located in a container adjacent the toilet when not in use and has a handle attached to the brush to allow a user to manipulate the same. However, a problem with toilet brushes is that they are unhygienic, often produce drips on the toilet or surfaces surrounding the toilet in use, they are not aesthetically pleasing and often can look unsightly after use.

GB2427124 discloses a spray jet cleaner for cleaning a toilet bowl. The cleaner is hung next to the toilet when not in use and interchangeable venturi heads are provided for use with the cleaner to provide different spray patterns.

GB2404351 discloses spray apparatus for cleaning toilet bowls including a spray head connected to a water hose. The spray head includes a casing having an inlet, an outlet and a chamber within the casing to receive a cleansing medium. Water flows over the cleansing medium in use. A removable cover is provided to allow access to the chamber and a depressible hand operated valve allows user control of the flow of water through the spray head.

It is an aim of the present invention to provide improved toilet apparatus.

It is a further aim of the present invention to provide an improved dispensing or cleaning device for use with toilet apparatus.

It is a yet further aim of the present invention or provide a method of using toilet apparatus or a dispensing device.

According to a first aspect of the present invention there is provided toilet cleaning apparatus, said apparatus including dispensing means for dispensing fluid therefrom for cleaning said toilet and connection means for connecting said dispensing means to a fluid supply for providing a source of fluid to the dispensing means in use, said dispensing means including a housing having fluid inlet means and fluid outlet means, and wherein said housing includes two or more parts and said parts are rotatably mounted to each other in use.

Preferably the toilet apparatus also includes at least a toilet bowl and the toilet cleaning apparatus is preferably used for cleaning said toilet bowl.

Preferably the dispensing means are movable relative to the toilet bowl in use. This allows fluid to be dispensed in a user selected arbitrary direction and/or at a user selected arbitrary location to allow specific and targeted cleaning of the toilet bowl using dispensed fluid.

The toilet bowl can include or comprise any suitable bathroom receptacle, such as a conventional toilet bowl, bidet, urinal and/or the like.

Preferably the toilet apparatus includes flush means for allowing flushing of the toilet bowl in use. Operation and/or use of the dispensing means is typically a separate and independent operation to the flush means.

In one embodiment the flush means includes a fluid reservoir, such as a toilet cistern, in communication with the toilet bowl and, on actuation of a flush in use, fluid from the fluid reservoir or toilet cistern can flow into the toilet bowl at one or more fixed or pre-determined positions.

Preferably the fluid reservoir or toilet cistern receives fluid from fluid conduit means. The connection means of the dispensing means can be associated with the fluid conduit means to allow the fluid source for use with the toilet cistern in use to also be used as the fluid source for the dispensing means.

Preferably the fluid is water and in one embodiment the water is supplied from a mains water supply.

The fluid dispensing means can receive fluid from any suitable source which can be separate to or associated with the fluid in the fluid reservoir. Thus, for example, the fluid dispensing means can receive fluid directly from a mains water supply. Alternatively, the fluid dispensing means can receive fluid from the toilet cistern, fluid reservoir, fluid conduit means and/or independent fluid source.

Preferably the dispensing means is provided with a substantially flexible conduit or hose between said connection means and the fluid inlet means of said dispensing housing, thereby allowing the dispensing means to be easily moved relative to said toilet bowl and/or said fluid supply.

Preferably the fluid conduit or hose is of such a length and/or dimensions to allow the dispensing means to be moved between a storage position, a spaced distance apart from the interior surface of said toilet bowl, and an “in-use” position, in or adjacent the interior surface of said toilet bowl.

Support or holder means can be provided for supporting the fluid dispensing means in the storage position adjacent to or in proximity to the toilet apparatus when not in use.

Preferably the two or more parts of said dispensing housing are provided with complementary screw threaded portions to allow said parts to be rotatably mounted to each other. Other attachment means could be provided between two or more parts of said dispensing housing. These attachment means can include any suitable attachment, such as one or more screws, clips, nuts and bolts, adhesive, ties and/or the like.

Preferably said two or more housing parts are detachably attached to each other to allow the housing to be disassembled, cleaned and/or repaired. At least one complete revolution or rotation of said housing parts can be used to separate two or more parts of said housing in one example.

Preferably control means are associated with the dispensing means to allow said dispensing means to be moved between an “on” condition, wherein fluid can be dispensed therefrom, and an “off” condition, wherein fluid is prevented from being dispensed. In addition to or alternatively, the control means can be used to adjust the volume and/or pressure of the fluid being dispensed from said dispensing means.

The control means preferably includes a valve arrangement. The valve arrangement can be controlled via any suitable means such as manually, electrically, pneumatically, hydraulically, mechanically and/or the like.

User actuation means can be associated with the control means to allow user actuation of said valve arrangement. The user actuation means can include any or any combination of one or more dials, handles, buttons, switches, knobs and/or the like.

In a preferred embodiment the user actuation means and/or control means is associated with one or more of the rotatably mounted housing parts. At least partial rotation of at least one of said housing parts relative to an adjacent part typically actuates the control means and/or said user actuation means.

The control means can be provided on or associated with the fluid dispensing means or on the fluid conduit, mains water supply and/or the like.

The same or further control means can be provided on or associated with the fluid dispensing means for controlling the volume, pressure, temperature, direction and/or the like of the fluid being dispensed therefrom.

Preferably said fluid dispensing means includes outlet means for dispensing of fluid therefrom. Further preferably the outlet means includes one or more fluid jets or nozzles.

Preferably two different types of fluid nozzles or jets are provided on the dispensing means, the different fluid nozzles dispensing fluids at different pressure, volumes, spray patterns, temperature and/or the like.

Preferably the fluid outlet means are defined in one of said housing parts and further preferably the outlet means are defined in an upper housing part.

Preferably the fluid inlet means are defined in one of said housing parts and further preferably the inlet means are defined in a lower housing part.

At least one channel is defined in the housing of the dispensing means to allow fluid to pass from said fluid inlet means to said fluid outlet means. Preferably a channel is defined in each of the housing parts.

Preferably the housing is substantially elongate in form, such as for example a cylindrical rod, and the at least one channel runs substantially parallel to the longitudinal axis of said housing.

Preferably at least one compartment is defined in said housing. Further preferably access to said compartment is provided by separating two or more parts of said housing, such as by unscrewing the screw threads and/or the like. The housing channel is typically in communication with said compartment.

Preferably a cleaning product, medium or suitable substance is located between said parts, in said compartment and/or in said channel in use to allow a cleaning product or suitable substance to be released from the dispensing means in use. Alternatively, or in addition, a cleaning product or suitable substance can be provided in or associated with the fluid conduit means, fluid source and/or the like.

The fluid being dispensed from the dispensing means preferably flows past or through the cleaning product or suitable substance in use to allow at least a part of said cleaning product or substance to be mixed, dissolved or contained in the fluid.

Location means can be provided to maintain the position of the cleaning product, medium or substance in a required position in said dispensing means, compartment and/or channel. The location means can include one or more ribs, flanges, clips and/or the like.

Preferably the cleaning product or suitable substance includes a cartridge or carrier in or on which the cleaning product or suitable substance is supported in use.

The cleaning product or substance can be provided or sold separately to the fluid dispensing means or as a part thereof. The cleaning product or substance is preferably at least partially soluble in water/fluid. Further preferably the product or substance colours the fluid/water when it is at least partially dissolved therein so that a user can determine when the product or substance is present.

Gripping means can be provided on an external surface of said dispensing means to allow a user to grip the same in use. The gripping means can include a high friction surface, one or more protrusions protruding outwardly from said surface, a knurled surface and/or the like.

Preferably the gripping means are provided on one or more external surfaces of the housing parts associated with the control means and/or user actuation means.

Fluid flow control means can be provided in said housing to allow control of the flow of fluid therethrough in use. The fluid flow control means in one embodiment is in the form of a valve arrangement.

Pressure control means can be provided in said housing to allow control of the pressure of fluid flowing therethrough in use. The pressure control means in one embodiment is in the form of a valve arrangement. The control of pressure can be controlled by adjusting the number of type of outlet nozzles fluid is dispensed through.

Preferably sealing means are provided to ensure that fluid is directed in the correct direction through the dispensing apparatus and/or to prevent fluid flow to certain areas of the dispensing apparatus. The sealing means can include one or more sealing washers and/or the like.

In one embodiment the valve arrangement(s) are such that fluid flows around at least part of an exterior surface of the valve (i.e. between an outer surface of the valve and an inner surface of a valve housing or the dispensing housing part. This design allows the dimensions of the valve to be made smaller than with conventional valve designs.

Preferably one or more fluid apertures can be defined in the valve and/or valve housing and fluid passes from one of an interior surface of the valve or valve housing to the other of an exterior surface of the valve or valve housing or vice versa.

In one embodiment of the fluid flow control means, the valve arrangement(s) includes a valve housing and a valve closure element. The valve closure element is movable relative to the valve housing between open and closed positions.

Preferably movement of the valve closure element relative to the valve housing moves the valve closure element between a closed position, wherein at least part of said element engages with fluid inlet means and fluid flow through said valve is prevented, and an open position, wherein at least part of said element is moved a spaced distance apart from said fluid inlet means and fluid flows through said valve. Further preferably fluid flows around the exterior of the valve closure element and valve housing in the open position before passing through one or more fluid apertures defined in the valve housing.

In one embodiment the valve closure element is rotatably mounted in the valve housing. For example, the rotatable mounting can take place via complementary screw threads being provided on a portion of the valve housing and valve closure element. Rotation of the valve closure element in a first direction moves the same a spaced distance apart from the fluid inlet means, thereby allowing fluid to pass around the exterior surface of the valve closure element. Rotation of the valve closure element in a reverse direction moves the valve closure element into sealing engagement with the fluid inlet means, thereby preventing fluid flow around the exterior surface of the valve closure element.

Preferably the valve closure element is capable of undergoing reciprocal longitudinal movement of said valve housing and/or dispensing housing part.

In one embodiment of the pressure control valves, two or more fluid apertures are provided a spaced distance apart longitudinally of said valve, such that longitudinal movement of the valve with respect to a valve seat, closes at least one of said fluid apertures and opens at least one of said fluid apertures. Preferably the valve is movable between at least a first position, wherein a first fluid aperture is a spaced distance apart from the valve seat and fluid can flow therethrough and a second fluid aperture is engaged with the valve seat to prevent fluid flow therethrough; and a second position, wherein the first fluid aperture engages with the valve seat and fluid is prevented from flowing therethrough and the second fluid aperture is a spaced distance apart from the valve seat and fluid can flow therethrough.

Preferably fluid flows through a central outlet nozzle when the first fluid aperture is open, and fluid flows through one or more peripheral outlet nozzles when the second fluid aperture is open.

In one embodiment the housing includes at least three detachably attached parts, a first part with fluid outlet means associated therewith, a second part with fluid inlet means associated therewith and an intermediate part provided between said first and second parts. The cleaning medium can be provided in said intermediate part or any other part as required.

In a preferred embodiment the pressure control means is provided in said first part and the fluid flow control means is provided in said second part.

Different dispensing heads can be provided with the housing. Thus, for example, the fluid outlet means can be defined in a housing part that can be interchanged with different housing parts having different arrangements of fluid outlet means. This allows different spray patterns of fluid to be provided. The fluid outlet means can be defined on a substantially planar or flat surface of said housing part in one embodiment, such that fluid is dispensed from substantially the same direction and/or height from said dispensing means.

A housing part can be provide which is substantially U or J-shaped and the fluid outlet means are defined in said U or J shaped portion. The U or J shaped portion allows fluid to be dispensed under a rim of the toilet bowl if required.

According to a further aspect of the present invention there is provided a method of using toilet cleaning apparatus, said apparatus including dispensing means for dispensing fluid therefrom for cleaning said toilet and connection means for connecting said dispensing means to a fluid supply for providing a source of fluid to the dispensing means in use, said dispensing means including a housing having fluid inlet means and fluid outlet means, and wherein said housing includes two or more parts and said parts are rotatably mounted to each other in use, said method including the steps of directing the fluid outlet means of the dispensing means towards the interior of a toilet bowl and actuating the dispensing means to allow fluid to flow at a suitable location in said toilet bowl.

According to a further aspect of the present invention there is provided a valve arrangement for dispensing means.

According to a yet further aspect of the present invention there is provided fluid flow control means for use in dispensing means, said control means including a closure element movably mounted with respect to a housing, the closure element movable between an open position, wherein fluid can flow through the control means, and a closed position, wherein fluid is prevented from flowing through the control means, characterised in that one or more fluid apertures are defined in the housing and, with the control means in the open position, fluid flows around at least part of the exterior surface of the closure element and housing and into the interior of the housing through said fluid apertures.

According to a yet further aspect of the present invention there is provided fluid pressure control means for use in dispensing means, said control means including a closure element movably mounted with respect to a housing, the closure element having at least first and second fluid apertures defined therein which are movable between an open position, wherein fluid can flow through said first and/or second apertures, and a closed position, wherein fluid is prevented from flowing through said first and/or second apertures, and wherein said control means are arranged such that the first aperture is open when the second aperture is closed and vice versa.

It will be appreciated that the present invention is easy to use, is aesthetically pleasing and is hygienic compared to conventional cleaning methods. The dispensing means can be used in addition to or as an alternative to a conventional toilet flush or toilet brush. The fluid dispensing means can be retrofitted to any existing toilet apparatus.

The dispensing means can also be used as an air-freshener by incorporating a pleasant odour containing component in the device. Disinfectant and/or anti-limescale compositions can also be contained in the dispensing means if required.

Embodiments of the present invention will now be described with reference to the accompanying figures, wherein:

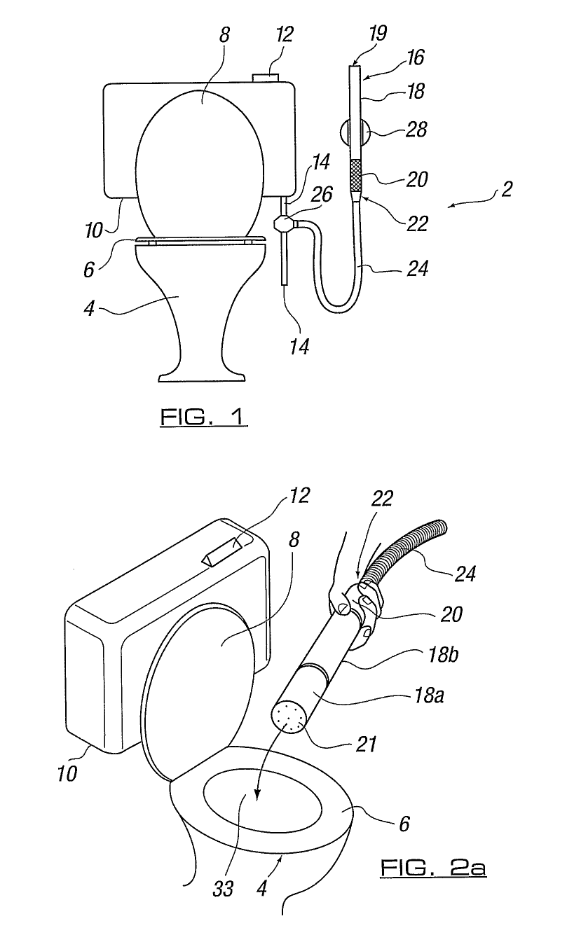

FIG. 1 is a front view of toilet apparatus according to the present invention in an “out-of-use” position;

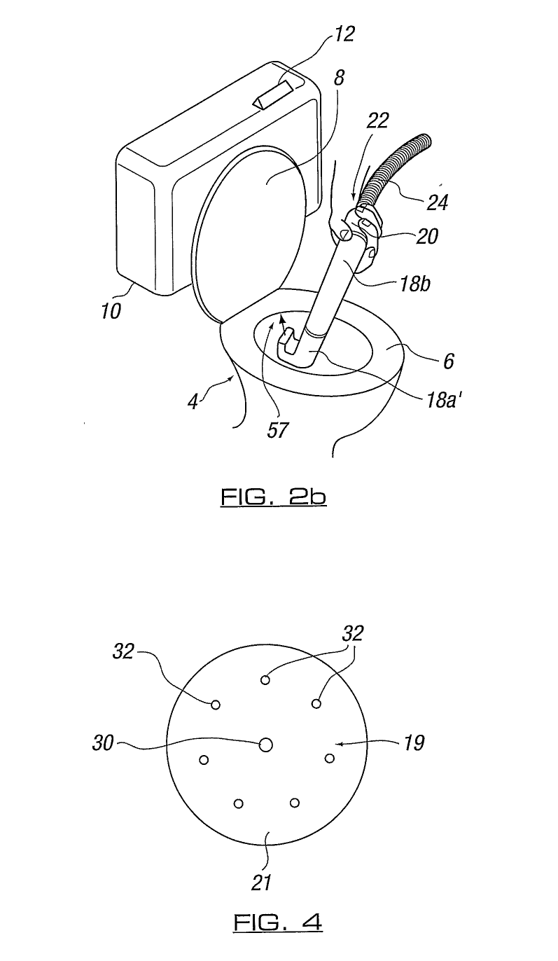

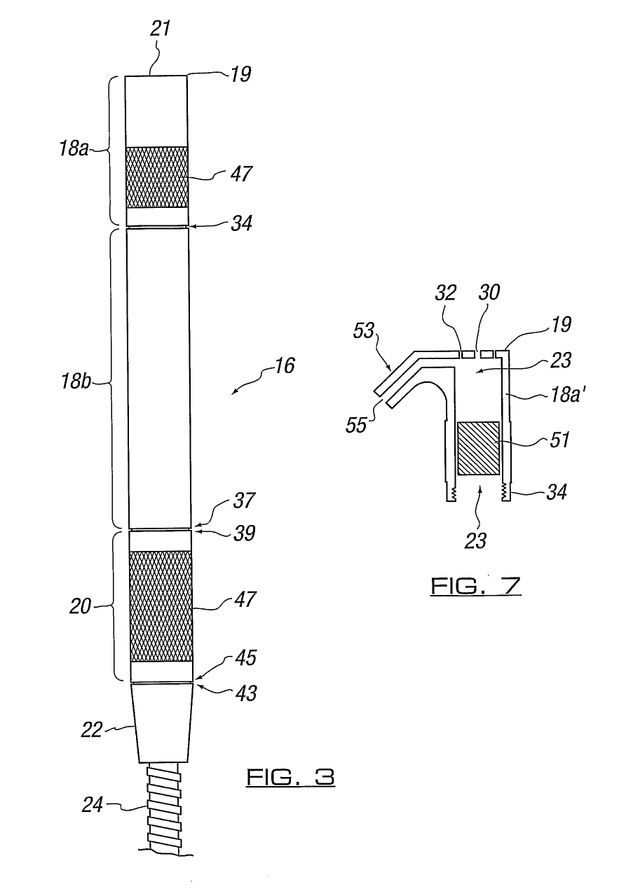

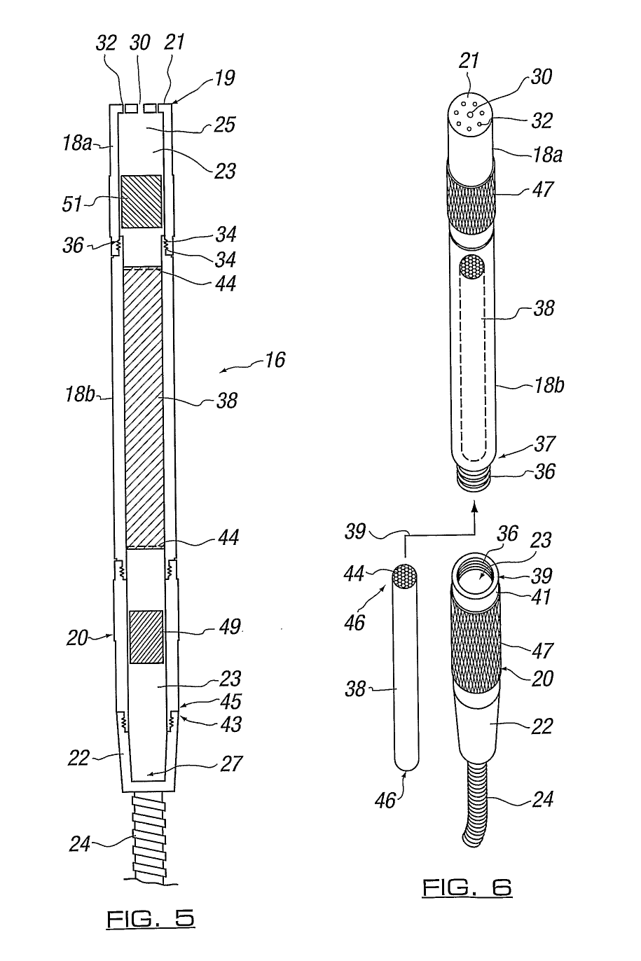

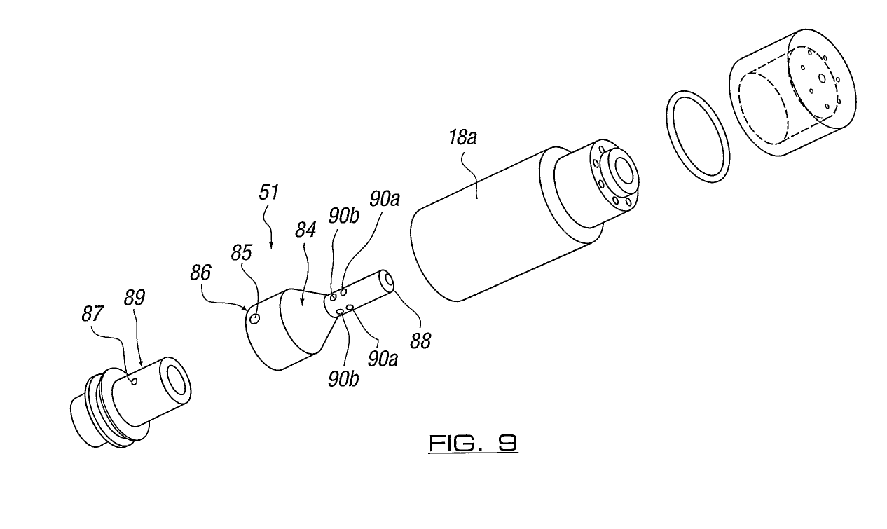

FIGS. 2a and 2b show perspective views of toilet apparatus with the dispensing means shown in FIG. 4 and FIG. 7 respectively in an “in-use” position;

FIG. 3 is a detailed view of the dispensing means in FIG. 1;

FIG. 4 is a plan view of the front end of the dispensing means in FIG. 3;

FIG. 5 is a cross sectional view taken through the dispensing means in FIG. 3;

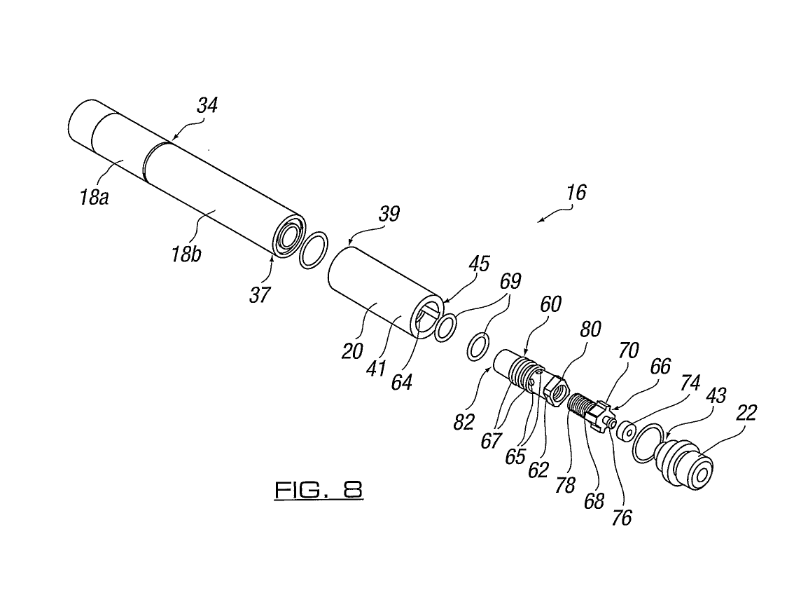

FIG. 6 shows a partially exploded view of the dispensing means in FIG. 3;

FIG. 7 is a cross sectional view taken through part of a dispensing head according to a further embodiment of the present invention;

FIGS. 8 and 9 show exploded views of the dispensing means with valve arrangements in one embodiment of the present invention; and

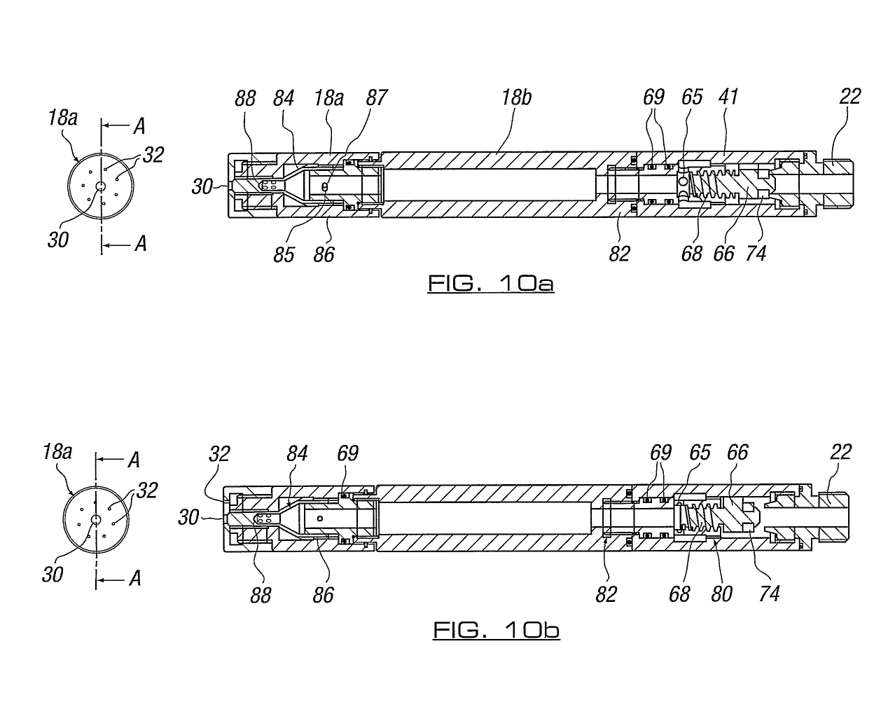

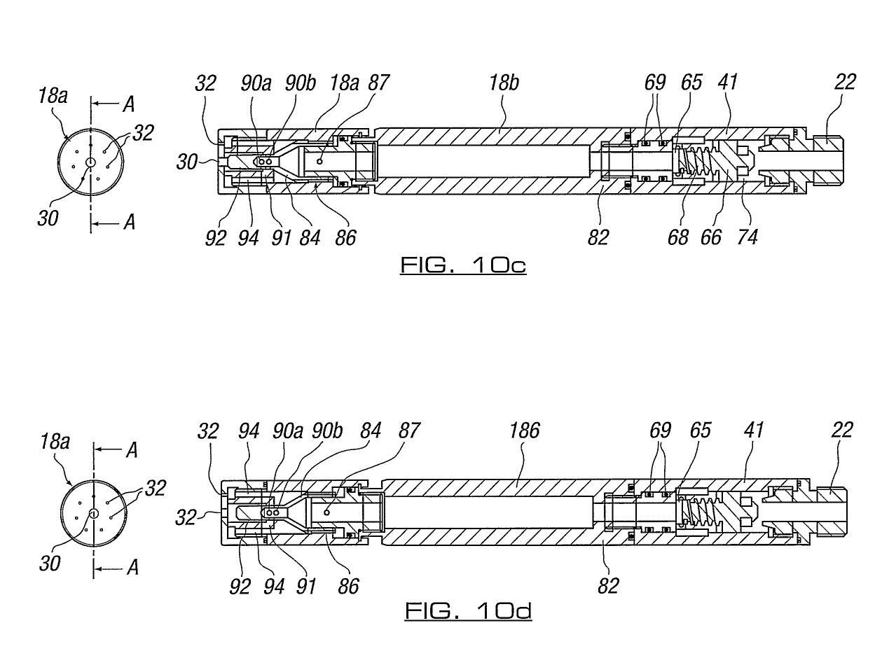

FIGS. 10a-10d illustrate cross sectional views of the dispensing means with the main flow control valve closed; with the main flow control valve open and the fluid pressure control valve closed; with the main flow control valve open and the fluid pressure control valve open allowing fluid flow from a central dispensing nozzle; and with the main flow control valve open and the fluid pressure control valve open allowing fluid flow from a peripheral dispensing nozzle or nozzles respectively.

Referring to the figures, there is illustrated toilet apparatus 2 including a toilet bowl 4 having a toilet seat 6 located on an upper edge of toilet bowl 4, a toilet lid 8 and a fluid reservoir in the form of a toilet cistern 10.

The toilet seat 6 and toilet lid 8 are typically hingedly mounted on toilet bowl 4 for moving relative to the toilet bowl in a conventional manner.

The toilet cistern 10 is connected to the toilet bowl via a conduit (not shown). When a user actuates a flush handle 12, water contained in cistern 10 passes along the conduit and into an upper portion of the toilet bowl 4. This flushing water acts to clear the toilet bowl after use via a siphon action and also has a partial cleaning effect as a result of the water passing over at least part of the surface of the toilet bowl. The water supplying the cistern 10 comes from a mains water supply via inlet conduit 14.

In accordance with the present invention there is provided dispensing means in the form of a water dispenser 16. The water dispenser 16 includes an elongate body portion 18 having a first end 19 with fluid outlet means for allowing the ejection of water therefrom, user control means 20 provided on the body, and a second end 22 including fluid inlet means connected to a water conduit 24. The body portion can be ergonomically designed to increase the ease of a user handling the same.

Water conduit 24 is typically connected to mains water inlet conduit 14 via a valve arrangement 26. The valve arrangement allows the water supply to the water dispenser 16 to be moved between “on” and “off” conditions. Any suitable type of valve arrangement can be used and any suitable user actuation means can be provided with the valve arrangement to allow the valve to be moved between the on and off conditions. For example, a tap can be provided on the valve arrangement, a self cutting valve can be used and/or the like.

In one embodiment of the present invention, as shown in FIGS. 2a, 3-6, the fluid outlet means at the first end 19 of the water dispenser 16 is a substantially flat or planar surface with a substantially central nozzle 30 and a plurality of nozzles 32 located around the peripheral edge thereof. The nozzles 30, 32 are formed such that the central nozzle 30 allows a high pressure jet of water to be dispensed therefrom and the peripheral nozzles 32 allow lower pressure jets of water to be dispensed therefrom. It will be appreciated that the fluid outlet nozzles can be provided in any suitable pattern or in any suitable arrangement.

A further arrangement of fluid outlet nozzles is shown in FIGS. 2b and 7 and will be described in more detail below.

The body portion 18 has a channel 23 passing through the interior thereof and a first end 25 of the channel communicates with the nozzles 30, 32 at first end 19 of the water dispenser, and a second end 27 of the channel communicates with the water conduit 24. As such, with the valve arrangement 26 in an “on” condition, water can pass from the mains water conduit 14, along conduit 24, through the channel 23 defined in body portion 18 and out through the nozzles 30, 32.

Control means 20 can be used to control the flow of water through the water dispenser 16 by opening and closing channel 23. Further control means can be used to adjust the pressure of the water flowing through the nozzles 30 or 32 and/or can be used to adjust which of the nozzles 30, 32 the water is dispensed from. For example, a user may only require water to be dispensed via the central nozzle 30. Alternatively, the nozzle may require water to be dispensed from all the nozzles 30, 32.

In use of the device in FIG. 2a, once a user has finished with the toilet, if the user wishes to clean the interior surface 33 of the toilet bowl 4 in addition to the toilet flush, such as for example by directing the cleaning process towards one or more specific locations on the interior surface 33 of the toilet bowl as they would normally do conventionally with a toilet brush, the user grips the elongate body portion 18 in one hand and directs the nozzles 30, 32 towards the interior of the toilet bowl. The user then switches the water dispenser 16 to an “on” condition and water is ejected from nozzles 30 and/or 32. Control means 20 can be adjusted to provide the required level of water pressure from the nozzles necessary to provide a required level of cleaning in the toilet bowl. The force of the water against interior surface 33 helps to remove any marks or soiling of the toilet bowl. The user selected arbitrary and directed nature of the water dispensed from the water dispenser 16 provides a greater cleaning effect than a conventional flush and is significantly more hygienic than a conventional toilet brush, due to the dispenser not actually coming into direct contact with the interior surface of the toilet bowl in use.

The conduit 24 is typically of such a length to allow the elongate body 18 of the dispenser to be moved close to and preferably inside the toilet bowl 4. In addition, conduit 24 is typically substantially flexible to allow the dispenser to be easily manipulated and moved to any required angle relative to toilet bowl 4. This allows accurate cleaning to be undertaken.

It will be appreciated that in some types of toilet systems, the water dispenser can be used in place of a conventional toilet flush. However, in a preferred embodiment, the water dispenser is used in addition to the conventional toilet flush.

Support means in the form of a holder device 28 can be mounted on the wall adjacent the toilet for holding the water dispenser 16 in an “out of use” or storage position. The holder device 28 typically maintains the dispenser with the first end 19 uppermost to ensure that any residual water left in the body portion or conduit 24 after use does not spill out onto the floor surrounding the toilet. However, it will be appreciated that the holder device can be in any suitable form, such as a hook, clip, friction fit, inter-engaging member and/or the like and can hold the water dispenser in any suitable manner or orientation. In addition, to prevent further spillage of water or fluid from end 19, valve 51 blocks the flow of water when the water supply is turned off by valve 49.

The elongate body portion 18 can be provided in two parts; a top part 18a and an intermediate part 18b, the ends 34 of which are detachably attached together via a rotatable mounting in the form of a complementary screw thread arrangement 36. The two parts 18a, 18b can be separated via unscrewing of the screw thread arrangement. End 37 of intermediate part 18b is detachably attached via a rotatable mounting in the form of a complementary screw thread arrangement 36 to end 39 of base part 41, at least a part of base part 41 forms control means 20. Water inlet means 22 can also be detachably attached via a rotatable mounting in the form of a complementary screw thread arrangement to end 45 of base part 41 via end 43. Thus, the water dispensing head in the illustrated embodiment comprises four parts which are detachably attached to each other via rotatable mountings, thereby allowing easy dismantlement for cleaning and/or repair. It will be appreciated that fewer or greater number of parts can be provided to form the dispensing head if required.

One or more cleaning products, disinfectants, odourous products and/or the like can be inserted in or in association with the fluid channel 23 at any suitable location. The products can be easily inserted by unscrewing any suitable parts of the dispensing head and locating the product in channel 23.

In the illustrated embodiment, a cartridge 38 containing a disinfectant can be located in the channel 23, as shown by arrow 39 in FIG. 6, to allow disinfectant to be mixed with the fluid dispensed from dispenser 16. More particularly, cartridge 38 is located in a compartment defined in channel 23 in intermediate part 18b. Location means can be provided in the channel 23 in intermediate part 18b to allow the cartridge to be retained in position in use. Mesh 44 provided at opposite ends 46 of cartridge 38 allows water to pass through the cartridge from end to end as it flows through the channel 42. As water passes through the cartridge, at least part of the disinfectant dissolves in the fluid to produce a cleaning fluid for dispensing. The cartridge can be replaced as often as required in order to maintain a required concentration of cleaning product in the water.

The water dispenser can be formed from any suitable material, such as plastic, metal, rubber and/or the like. The dispenser can also be of any suitable size, shape and/or design. Preferably the dispenser is aesthetically pleasing and can be matched to any interior design within the bathroom or toilet in which it is to be located.

Gripping means in the form of knurled exterior surfaces 47 can be provided on top part 18a and base part 41 to allow a user to easily grip the exterior surface of the dispensing head. Gripping means could be provided at any suitable location and/or in any form on the dispensing means.

A flow control valve 49 is provided in base part 41 forming part of the control means for allow control of the flow of fluid through dispensing head 16. A pressure valve 51 is provided in top part 18a to allow control of the fluid pressure being dispensed from the dispensing head. Operation of the valves can be via rotation of one or more parts of the device in a suitable manner. Thus, for example, partial or a small amount of rotation of one or more of the parts may adjust the valve or valves.

FIG. 7 illustrates a further embodiment of top part 18a′ of dispensing head 16 in which a further outlet nozzle 53 is provided and outlet aperture 55 defined at an end of nozzle 53 typically protrudes in a different angle or direction to outlet nozzles 30, 32 to allow fluid to be dispensed at a different angle. In this illustrated embodiment nozzle 53 points in a substantially opposite direction to outlet nozzles 30, 32, thereby allowing water to be easily dispensed under a toilet rim of the toilet bowl 4, as shown by arrow 57 in FIG. 2b. Nozzles 30, 32 may not be required in top part 18a′ and can be omitted.

Referring to FIGS. 8, 10a-10d, an exploded view of the water dispenser 16 is shown. Flow control valve 49 includes a valve housing 60 which is of slightly smaller dimensions that the channel 23 defined in base part 41. Valve housing 60 has outwardly protruding location arms 62 at a first end 62 thereof to allow engagement with and location in corresponding recesses 64 defined in part 41. The valve housing 60 is fixed in place in the housing base part 41. Fluid apertures 65 are defined in an outer wall of the valve housing. Circumferential grooves 67 are provided at spaced apart locations on the external surface of housing 60 and sealing washers 69 are located in said grooves 67 in use. The sealing washers prevent the flow of fluid past the same. The sealing washers 69 are located on the side of the fluid apertures closest to the fluid outlet means.

A valve closure element 66 is movably mounted in valve housing 60 via screw threads 68 which are complementary to screw thread portions provided on the interior walls of valve housing 60. The screw threads allow valve closure element 66 to be rotatably moved longitudinally of valve housing 60 and thus of base part 41. Thus, rotation of base part 41 with respect to housing part 18b causes closure element 66 to be rotated with respect to valve housing 60 between open and closed positions. Closure element 66 can move between ends 80 and 82 of valve housing 60 in a reciprocating manner when rotated.

End 76 of closure element 66 is attached to a valve seat component 74. When the valve 49 is in a closed position, the valve seat 74 engages with or in a channel defined in water inlet means 22, as shown in FIG. 10a, thereby preventing fluid from flowing past the valve seat towards the fluid outlet means. When the valve 49 is in an open position, the valve seat 74 is moved a spaced distance apart from the water inlet means 22, as shown in FIG. 10b, thereby allow fluid to flow past the valve seat towards the fluid outlet means.

When the valve 49 is in an open position, the valve seat 74 is moved a spaced distance apart from the water inlet means 22 and end 78 of the closure element 66 is moved towards end 82 of valve housing 60. Fluid flows through the water inlet means 22, around the external surface of end portion 80 of valve housing 60. The water is prevented from flowing towards opposite end 82 of valve housing 60 due to sealing washers 69. As such, the water passes through fluid apertures 65, into the interior channel of valve housing 60 and along the interior channel defined in base part 41.

When the valve 49 is in a closed position, the valve seat 74 engages with the water inlet means 22 and end 78 of closure element 66 is moved towards end 80 of valve housing 60. Water flows through water inlet means 22 but cannot pass valve seat 74.

Referring to FIGS. 9, 10a-10d, an exploded view of top part 18a of the water dispenser is shown. Pressure valve 51 includes a valve housing 84 having a first end 86 which is larger in diameter than an opposite end 88, thereby providing a tapered shape to said valve 51 (i.e. the taper narrowing towards the fluid outlet end of the dispensing apparatus). The narrower end 88 faces towards the water outlet end of the dispensing apparatus and the wider end 86 faces towards the water inlet end of the dispensing apparatus. Fluid apertures 90 are defined adjacent the narrower end 88 of the valve housing 84. More particularly, fluid apertures 90a, 90b are arranged a spaced distance apart and longitudinally of the valve housing 84. Fluid flow through upper fluid aperture 90a allows fluid flow through central outlet nozzle 30 in use and fluid flow through lower fluid aperture 90b allows fluid flow through peripheral outlet nozzles 32 in use.

Location means in the form of a recess 85 is defined in the outer surface of valve housing 84 to allow valve housing to be rotated relative to a location housing 89 fitted in dispensing housing part 18b between open and closed positions. A protruding location arm 87 provided on location housing 89 is movable in location recess 85 to limit rotational and longitudinal movement between pre-defined limits. Sealing means in the form of sealing washers 69 prevent flow of fluid around the external surface of end 86 of valve 51. A valve seat 91 is defined on an interior surface of part 18a and the valve housing 84, and more particularly the fluid apertures 90a and 90b, are movable with respect to the valve seat 91 between open and closed positions.

When the flow control valve 49 is open, fluid flows through the channel defined in housing part 18b, through the interior of the channel defined at end 86 of valve housing 84 and flows to the exterior of valve housing 84 through either of apertures 90a, 90b.

With upper fluid aperture 90a located above valve seat 91 (i.e. the same side of valve seat 91 as outlet nozzle 30), as shown in FIG. 10c, fluid aperture 90b engages with valve seat 91, thereby preventing fluid flow through aperture 90b and directing all fluid flow through central outlet nozzle 30. Central outlet nozzle 30 typically communicates with fluid aperture 90a via a channel 92.

When the upper fluid aperture 90a is moved into engagement with valve seat 91, as shown in FIG. 10d, lower fluid aperture 90b is located below valve seat 91 (i.e. the opposite side of valve seat 91 to outlet nozzle 30), thereby preventing fluid flow through upper aperture 90a and directing allow fluid flow through peripheral outlet nozzles 32. Peripheral outlet nozzles typically communicate with fluid aperture 90b via a channel 94.

The pressure control valve 51 is controlled by rotation of upper housing part 18a with respect to lower housing part 18b and/or the outlet nozzle housing part

1. Toilet cleaning apparatus, said apparatus including dispensing means for dispensing fluid therefrom for cleaning said toilet and connection means for connecting said dispensing means to a fluid supply for providing a source of fluid to the dispensing means in use, said dispensing means including a housing having fluid inlet means and fluid outlet means, and wherein said housing includes two or more parts and said parts are rotatably mounted to each other in use.

2. Toilet cleaning apparatus according to claim 1 wherein the two or more parts of said housing are provided with complementary screw threaded portions to allow said parts to be rotatably mounted to each other.

3. Toilet cleaning apparatus according to claim 1 wherein said two or more parts are detachably attached to each other in use.

4. Toilet cleaning apparatus according to claim 1 wherein a compartment is defined in said housing and access to said compartment is provided by separating two or more of said housing parts.

5. Toilet cleaning apparatus according to claim 4 wherein a cleaning medium is contained in said compartment in use.

6. Toilet cleaning apparatus according claim 4 wherein the compartment is substantially elongate in form and is provided substantially parallel to the longitudinal axis of said housing.

7. Toilet cleaning apparatus according to claim 4 wherein the compartment is provided with location means for maintaining the position of a cleaning medium within the compartment in use.

8. Toilet cleaning apparatus according to claim 1 wherein the dispensing means includes control means for allowing a user to control the flow of fluid therethrough, the control means being actuated by at least partial rotation of one or more of said housing parts.

9. Toilet cleaning apparatus according to claim 8 wherein gripping means are provided on the exterior surface of at least the housing part associated with the control means.

10. Toilet cleaning apparatus according to claim 9 wherein said gripping means includes one or more protrusions protruding outwardly from an exterior surface of said housing part.

11. Toilet cleaning apparatus according to claim 1 wherein fluid flow control means are provided in said dispensing means for controlling the flow of fluid therethrough.

12. Toilet cleaning apparatus according to claim 1 wherein pressure control means are provided in said dispensing means for controlling the pressure of fluid flowing therethrough.

13. Toilet cleaning apparatus according to claim 1 wherein the housing includes at least three detachably attached parts; a first part with fluid outlet means associated therewith, a second part with fluid inlet means associated therewith and an intermediate part provided between said first and second parts.

14. Toilet cleaning apparatus according to claim 13 wherein a compartment is defined in said intermediate part.

15. Toilet cleaning apparatus according to claim 1 wherein said apparatus further includes a substantially flexible conduit or hose provided between the fluid inlet means of said dispensing means and the connection means.

16. Toilet cleaning apparatus according to claim 1 wherein the connection means includes a valve.

17. Toilet cleaning apparatus according to claim 1 wherein support means are provided for allowing the dispensing means to be supported in a suitable position when not in use.

18. Toilet cleaning apparatus according to claim 1 wherein the apparatus includes at least a toilet bowl.

19. Toilet cleaning apparatus according to claim 1 wherein the fluid outlet means are defined in a housing part and different housing parts having different arrangements of fluid outlet means can be provided.

20. Toilet cleaning apparatus according to claim 19 wherein the fluid outlet means are defined on a substantially planar or flat surface on said housing part.

21. Toilet cleaning apparatus according to claim 19 wherein at least a portion of the housing part is substantially U or J-shaped and the fluid outlet means are defined in said U or J shaped portion.

22. Toilet cleaning apparatus according to claims 11 or 12 wherein the fluid flow control means and/or the pressure control means includes a valve arrangement movable between open and closed positions.

23. Toilet cleaning apparatus according to claim 22 wherein in the fluid flow control valve arrangement, fluid flows from an external surface of a valve and/or valve housing to an interior surface of the valve or valve housing through one or more fluid apertures when said valve arrangement is in an open position.

24. Toilet cleaning apparatus according to claim 23 wherein the valve arrangement includes a closure element and a valve housing, the closure element being movably mounted with respect to said valve housing from an open position, wherein the closure element is a spaced distance apart from fluid inlet means and fluid can flow through said fluid inlet means, around at least part of an external surface of said closure element and through one or more fluid apertures defined in the valve housing to the interior of the valve housing; to a closed position, wherein the closure element engages with or adjacent said fluid inlet means to substantially prevent fluid flow through said fluid inlet means.

25. Toilet cleaning apparatus according to claim 22 wherein in the pressure control valve arrangement, fluid flows from an interior surface of the valve and/or valve housing to an external surface thereof through one or more fluid apertures when said apertures are in an open position.

26. Toilet cleaning apparatus according to claim 25 wherein at least first and second fluid apertures are defined a spaced distance apart and longitudinally of said valve, said valve movable longitudinally with respect to sealing means to allow selective opening of said first and/or said second fluid apertures.

27. Toilet cleaning apparatus according to claim 26 wherein the valve is movable with respect to the sealing means between a first position, wherein the first fluid aperture is open and fluid can flow therethrough and the second fluid aperture is closed and fluid is prevented from flowing therethrough; to a second position, wherein the first aperture is closed and fluid is prevented from flowing therethrough and the second aperture is open and fluid can flow therethrough.

28. Toilet cleaning apparatus according to claim 25 wherein the valve has a narrowing taper towards the outlet end of the dispensing apparatus, the one or more fluid apertures being provided towards said narrowing end of said valve.

29. A method of using toilet cleaning apparatus, said apparatus including dispensing means for dispensing fluid therefrom for cleaning said toilet and connection means for connecting said dispensing means to a fluid supply for providing a source of fluid to the dispensing means in use, said dispensing means including a housing having fluid inlet means and fluid outlet means, and wherein said housing includes two or more parts and said parts are rotatably mounted to each other in use, said method including the steps of directing the fluid outlet means of the dispensing means towards the interior of a toilet bowl and actuating the dispensing means to allow fluid to flow at a suitable located in said toilet bowl.
